(19) United States
(12) Patent Application Publication
(10) Pub. No.: US 2010/0272184 A1
(43) Pub. Date: Oct. 28, 2010

(54) System and Method for Real-Time Super-Resolution

(75) Inventors: Barak Fishbain, Shoham (IL); Ianir Ideses, Raanana (IL); Leonid Yaroslavsky, Kfar Saba (IL)

Correspondence Address: HOUSTON ELISEEVA, 420 BEDFORD ST, SUITE 155, LEXINGTON, MA, 02420, US

(73) Assignee: Ramot at Tel-Aviv University Ltd., Tel-Aviv (IL)

(21) Appl. No.: 12/833,973

(22) Filed: Jul. 10, 2010

Related U.S. Application Data
(63) Continuation of application No. PCT/IL2009/000045, filed on Jan. 11, 2009.
(60) Provisional application No. 61/020,305, filed on Jan. 10, 2008.

(51) Int. Cl. H04N 7/12

(52) U.S. Cl. 375/240.16; 375/E07.026

(57) ABSTRACT

A method and system are presented for real time Super-Resolution image reconstruction. According to this technique, data indicative of a video frame sequence compressed by motion compensated compression technique is processed, and representations of one or more video objects (VOs) appearing in one or more frames of said video frame sequence are obtained. At least one of these representations is utilized as a reference representation and motion vectors, associating said representations with said at least one reference representation, are obtained from said data indicative of the video frame sequence. The representations and the motion vectors are processed, and pixel displacement maps are generated, each associating at least some pixels of one of the representations with locations on said at least one reference representation. The reference representation is re-sampled according to the sub-pixel accuracy of the displacement maps, and a re-sampled reference representation is obtained. Pixels of said representations are registered against the re-sampled reference representation according to the displacement maps, thereby providing super-resolved image of the reference representation of said one or more VOs.

### FIELD OF THE INVENTION

This invention is generally in the field of image processing and relates to a system and method for real-time super-resolution.

### REFERENCES

The following references facilitate understanding of the background of the invention:
[1] B. Fishbain, L. P. Yaroslaysky and I. A. Ideses, “Real-time stabilization of long range observation system turbulent video”, Journal of Real-Time Image Processing Vol. 2(1), pp. 11-22, October 2007.
[2] L. P. Yaroslaysky, B. Fishbain, G. Shabat and I. Ideses, “Super-resolution in turbulent videos: making profit from damage”, Optics Letters, Vol. 32(20), pp. 3038-3040, 2007.
[3] I. E. G. Richardson, H.264 and MPEG-4 Video Compression Video Coding for Next-generation Multimedia, John Wiley, England 2003.
[4] V. Bhaskaran and K. Konstantinides, Image and Video Compression Standards, Norwell, M A: Kluwer, 1995.
[5] G. M. Callico, A. Nunez, R. P. Llopis, R. Sethuraman, “Low-cost and real-time super-resolution over a video encoder IP”, Proceedings. Fourth International Symposium on Quality Electronic Design, pp. 79-84, San-Jose Calif.-USA, 24-26 March 2003.
[6] P. J. S. G. Ferreira, “Interpolation and the Discrete Papoulis-Gerchberg Algorithm”, IEEE Transactions on Signal Processing, Vol. 42(10), pp. 2596-2606, 1994.
[7] A. Papoulis, “A New Algorithm in Spectral Analysis and Band-Limited Extrapolation”, IEEE Transactions on Circuits and Systems Vol. 22(9), pp. 735-742, 1975.
[8] T. Brox, A. Bruhn, N. Papenberg & J. Weickert, High Accuracy Optical Flow Estimation based on Theory for Wrapping, Proc. 8th European Conference on Computer Vision, Prague, Czech Republic, 2004, 4:25-36.
[9] L. Yaroslaysky, Digital Holography and Digital Image Processing, Kluwer Scientific Publishers, Boston, 2004
[10] Z. Chen, J. Xu, Y. He and J. Zheng, “Fast integer-pel and fractional-pel motion estimation for H.264/AVC”, Journal of Visual Communication and Image Representation, Vol. 17(2), Pages 264-290, April 2006.
[11] A. M. Tourapis, “Enhanced predictive zonal search for single and multiple frame motion estimation,” in Proc. of Visual Communications and Image Processing (VCIP), pp. 1069-1079, San-Jose Calif., January 2002.

### BACKGROUND OF THE INVENTION

In the recent years, with the evolvement of High Definition (HD) video standard, such as HDTV and other high resolution video representation devices, there is an increasing demand for high definition video content. At the same time, there is a significant lack of HD video content where the majority of TV channels and DVD movies are encoded with standard-definition (SD).

Some known techniques for converting an SD video stream to HD video stream include intra-frame (spatial) resolution upsizing, typically utilizing interpolation methods such as bilinear or bicubic interpolation. Generally, techniques based on intra-frame interpolation utilize the information already existing in the original video frame in order to enhance the frame's resolution and to synthesize artificial details into a high resolution image.

Another approach, generally referred to as Super-Resolution (SR), is based on image reconstruction technique, utilizing signal processing methods to obtain high-resolution (HR) image (or sequence of HR images e.g. video sequence) from a sequence of multiple low-resolution (LR) images. According to this technique, the resolution enhancement of the image of a video frame is based on the extraction of visual information existing in the sequence of frames. This enables to combine the information of several low resolution images/video frames containing slightly different views of the same scenery, and to reconstruct therefrom enhanced SR video frame(s) which include details of the imaged scenery that were not included together in any one of the frames of the original, low resolution, video sequence.

Widely used digital image sensors include charge-coupled devices (CCD) and CMOS cameras. Increasing the imaging resolution of such an imaging sensor might be achieved by increasing its spatial resolution and the size of a sensing surface. Alternatively, signal processing techniques, such as SR methods, might be used to enhance the effective resolution of an imaging device without the use of high spatial resolution sensor. The major advantage of the signal processing approach is that it may cost less and the existing LR imaging systems can be still utilized.

Basically, recovering high-frequency visual information of the scenery (i.e. associated with high resolution imaging) from a sequence of (LR) images of the same scene is possible if the differences between the images provide additional information of the scene. A typical video sequence of a scene comprises unstable images of the scene, i.e. containing pixels that are shifted between the frames, e.g. due to global/camera motion or different environmental conditions affecting the environment's refraction index (e.g. turbulent air flow etc.). Generally, high frequency information of the scene is introduced into the sequence of LR images through small distance (e.g. sub-pixel) displacements of the sampling grid (pixel array/CCD) with respect to the scenery. It is thus required for the Super Resolution image reconstruction process that the LR images of the scenery contain different but related views of the scene. In a typical sequence of video frames presenting a scene, the frames are sub-sampled (aliased) as well as shifted from one another with sub-pixel precision. The sub-pixel differences (e.g. shifts) between the frames and the aliasing introduce new information of the scene (e.g. each image/frame cannot be obtained from the others) that can be exploited to reconstruct an SR image of the scene. It should be understood that the images or portions thereof, shifted from one another by integer units (pixels), do not contribute any new information that can be used in an SR reconstruction process.

Sub-pixel differences within the video sequence typically occur due to the scene motions, namely global motion of the imaging system with respect to the scenery (i.e. background motion, e.g. camera motion, images acquired from orbiting satellites or vibrating imaging systems) and/or due to foreground motion of local objects within the scene. Some differences between a sequence of images occur in the process of recording the images, due to, for example, a natural loss of spatial resolution caused by the optical distortions (out of focus, diffraction limit, etc.), motion blur due to limited shutter speed, noise that occurs within the sensor or during transmission, and insufficient sensor density. Thus, the recorded image usually suffers from blur, noise, and aliasing effects. Although the main concern of an SR algorithm is to reconstruct HR images from under-sampled LR images, it might also be used as a restoration technique for reconstructing high quality images from noisy, blurred images or otherwise degraded and aliased LR images.

Additionally, in some types of imaging systems, such as long distance observation systems, images and video are frequently damaged by atmospheric turbulence, causing spatially and temporally chaotic fluctuations in the index of refraction of the atmosphere resulting in chaotic, spatial and temporal geometrical distortions of neighborhoods of all pixels. This geometrical instability of image frames heavily worsens the quality of videos and hampers their visual analysis. To make visual analysis possible, it is required first of all to stabilize images of stable scenes while preserving real motion of moving objects that might be present in the scene. Methods of generating stabilized videos from turbulent videos, including real time ones have been developed [1, 2], arriving to an advanced technique of making a profit from atmosphere turbulence-induced image geometrical spatial/temporal degradations to compensate image sampling artifacts and generate stabilized images of the stable scene with higher resolution than that defined by the camera sampling grid.

The SR image reconstruction is proved to be useful in many practical cases where multiple frames of the same scene can be obtained, including medical imaging, satellite imaging, and video applications.

### SUMMARY OF THE INVENTION

There is a need in the art for a novel SR method capable of being used in real-time image processing.

It should be understood that the known SR methods generally utilize and analyze the raw sequences' frames, without taking into consideration the presence of moving objects. Accordingly, SR is achieved through computational complex algorithms.

Nowadays most digital footage data is transmitted and stored using the International Telecommunication Union (ITU) and Moving Picture Experts Group (MPEG) coding standards [3, 4]. These well known standards typically incorporate motion-compensated compression techniques used to reduce the volume of the video sequence data. Known SR techniques which are designed for manipulating raw, uncompressed, video sequences may not be efficient when applied to compressed video formats and are typically time consuming making them impractical for use in real time applications that utilize such compressed video formats.

Thus, there is a need in the art for SR techniques which are adapted to operate with compressed video data in real time with efficient and economical computation power requirements.

A real-time super-resolution method, adapted for use within a video decoder hardware, was suggested by Callico et al [5]. According to this method, a proprietary compression standard is used for the reconstruction of an SR video sequence. A video sequence encoded/compressed according to this standard comprises motion fields.

The method of the present invention takes advantage of another type compression standard termed motion compensated compression (such as MPEG), which includes global motion compensated (GMC) data. The invention utilizes such compression standard for efficient estimation of the global motion between frames thus enabling real-time SR processing, and uses various features of any known compression algorithm, such as video objects (VOs), for efficient background extraction.

It should be understood that in the scope of the present disclosure, the term motion-compensated compression technique refers to any video frame sequence compression technique utilizing inter-frame compression based on the evaluation and encoding of the relative motion (e.g. in the form of motion vectors) of one or more pixels (or groups of pixels) between two of more frames of the sequence.

SR methods are usually based on two important algorithms: high quality spatial (in-frame) re-sampling (e.g. upsizing), and motion compensation for finding corresponding areas in neighbor frames. Finding corresponding areas in neighboring frames (motion compensation algorithms) is typically time consuming operation involving complex search algorithms, such as Logarithmic Search, Hierarchical Search, Cross Search, Asymmetrical Cross Multi Hexagon-grid (AMHexagonS) and Enhanced Predictive Zonal Search (EPZS). In each case, the performance of the algorithm may be evaluated by comparison with Full Search. It should be noted that the term re-sampling (including up and down sampling) used in the present disclosure refers to a resolution manipulation applied to an image for increasing or reducing its resolution. Typically, this is achieved through different image interpolation methods such as discrete sinc-interpolation which is considered as having small interpolation error.

The technique of the present invention is based on the fact that typically, consequent frames of a video stream differ mostly due to small movements between the frames and thus the image sampling grid (e.g. defined by the video camera sensor) may be considered to be moving over a stationary image scene. This phenomenon allows for combining (with appropriate re-sampling) multiple frames of the video stream to thereby generate high resolution images of the scenery having large number of samples, larger than the number of samples of the scenery provided by the camera's sampling grid. The super-resolution process consists of two main stages: a determination, with sub-pixel accuracy, of pixel movements and a combination of data of several frames in order to generate a single combined image with higher spatial resolution.

In the first stage, in which pixels movement between frames is determined/estimated, mapping between unstable (e.g. turbulence/shift affected) images of the scene can be obtained by registering a spatial neighborhood surrounding each pixel in a first image against a second image. In its simplest form, it is sufficient to find, for each pixel, the translations along the x and y axes. Such a registration can be implemented using searching algorithms such as described above, optical flow methods [8] or correlation methods [9].

An SR enhancement thus preferably requires an efficient estimation of accurate sub-pixel-resolution motion fields (e.g. in the form of pixel displacement maps).

The inventors of the present invention take advantage of various features inherent to the common compression format standards (such as ITU H.264 or MPEG-4). These features provide for data structures (such as motion vectors) within the compressed video files which enables highly efficient super resolution methods for use with compressed video formats.

The present invention thus provides a method for super resolution image processing utilizing motion compensated video compression format standards such as MPEG. The method may be implemented within software and/or hardware systems to provide real-time processing of super resolution.

Generally, motion compensated video compression standards reduce redundant encoding of image data by utilizing inter-frame motion vectors to relate similar data sections between different frames. More particularly, MPEG-encoded image sequences are divided into groups of pictures (GOPs) composed of primarily three different frame types:
Intra-coded frames (I-frames which are coded independently without reference to any other pictures (e.g. using block-DCT (discrete cosine transform) compression).
Predictive-coded frames (P-frames) which are coded with references to the temporally preceding I- or P-pictures.
Bi-directionally predictive-coded frames (B-frames) which are coded with references to the nearest preceding and/or upcoming I- or P-pictures.

While the I-frames are coded independently of other frames, the P-frames take advantage of data existing in the previous (I or P) frames (being reference frames) to provide higher compression ratio. Such I-frame is a frame having a coded representation in the MPEG standard as consisting solely on the concurrent frame itself, rather than on preceding or proceeding frames. A P-frame is encoded (and compressed) using motion compensation predictions associating portions of the frame with previous frame(s), generally referred to as reference frame(s). It should be understood that a GOP may corresponds to a sequence of frames associated with a particular time window.

The frame, being encoded, is divided into macro-blocks (generally 16×16 pixels). Then the reference frame is searched to find therein macro-blocks that best-match to the macro-blocks of the frame being encoded. The offsets between the macro-blocks of the encoded frame and the best matching macro-blocks of the reference frame are encoded as “motion vectors” often having sub-pixels accuracy down to ¼ of a pixel. The residual differences between the macro-blocks of the encoded frame and the corresponding best-matching macro-blocks, found in the reference frame, are stored as a motion vector (e.g. associated with each macro-block) of the P-frame being compressed.

Similarly to P-frames, B-frames are encoded (and compressed) using motion compensation predictions associating portions of the frame with other frame(s). However, the motion compensation predictions may refer to the following frames as well as previous frames of the video sequence. As a result, B-frames usually provide more compression than P-frames but cannot serve as reference frames.

Video encoders utilizing motion compensated compression (i.e. MCC), such as MPEG encoders, typically employ motion estimation and compensation techniques to encode sequences of video frames in the form of GOPs each comprising at least one I-frame and one or more P or B frames which references to said at least one I-frame. These motion estimation and compensation techniques are aimed at finding a ‘match’ to the current block or region that minimizes the energy in the motion compensated residual (the difference between the current block in a first frame and the reference area on a second, e.g. reference frame). This usually involves evaluating the residual energy at a number of different offsets. The energy is typically measured by one of three energy measures, Mean Squared Error (MSE), Mean Absolute Error (MAE) and Sum of Absolute Error (SAE) as follows:

$$\begin{matrix}MSE = \frac{1}{{N}^{2}} {\sum }_{i , j ∈ Ω} {( {C}_{i , j} - {R}_{i , j} )}^{2} & ( 1 ) \\ MAE = \frac{1}{{N}^{2}} {\sum }_{i , j ∈ Ω} \vert {C}_{i , j} - {R}_{i , j} \vert & ( 2 ) \\ SAE = {\sum }_{i , j ∈ Ω} \vert {C}_{i , j} - {R}_{i , j} \vert & ( 3 )\end{matrix}$$

where the block size is N×N; C and R are the current (first frame) and reference frames respectively and Ω is the corresponding sampled areas. The choice of measure for ‘energy’ affects computational complexity and the accuracy and the SAE measure is generally the most widely-used measure of residual energy for reasons of computational simplicity.

As described above, the super-resolution process requires fractional translations (motion-vectors/pixel-displacement-maps heaving sub-pixels accuracy) rather than just integer values. The MPEG-4 standard provides for half-pixel vectors in MPEG-4 Simple Profile and quarter-pixel vectors in Advanced Simple profile and H.264. Sub-pixel motion estimation may be achieved, by the encoder, by utilizing interpolation techniques to interpolate between integer sample positions in the frames (e.g. for example up-sampling the entire frame). However interpolation is computationally intensive and calculating sub-pixel samples for the entire search window might not be necessary. Hence, alternatively the best integer-pixel match can be found (using one of the fast search algorithms discussed above) and then a search with interpolated positions adjacent to the position of the integer-pixel match is carried out. For example, in the case of quarter-pixel motion estimation, first the best integer match is found; then the best half-pixel position match in the immediate neighborhood is calculated; finally the best quarter-pixel match around this half-pixel position is found.

Generally, SR techniques utilize motion compensation/estimation algorithms very similar to those used by typical motion compensated compression encoders. The results obtained from these motion compensation algorithms are further used to facilitate registration, with sub-pixel accuracy, of the values of pixels in a first frame against sub-pixel positions within a second frame. The inventors have found that video sequences encoded by an MCC encoder already contain within the encoded data the results of such algorithms and thus the encoded data (e.g. in the form of motion vectors) may be used for the efficient SR processing as will be further described below.

Hence, according to the present invention, a typical GOP of an MPEG encoded video sequence may be used for an efficient reconstruction of super resolution images of one or more frames of the GOP. Typically, a GOP encodes a sequence of video frames beginning with an I-frame (I picture) and including additional P- and B-frames. It should be noted that a digital image sequence coded at a low bit rate using a motion-compensated video compression standard should contain little data redundancy. However, the success of a particular super-resolution enhancement algorithm is predicated on sub-pixel-resolution overlap (i.e., redundancy) of moving objects from frame-to frame. If an MPEG bit stream is coded at a relatively high bit rate (e.g., a compression ratio of 15:1), enough data redundancy exists within the bit stream to successfully perform super-resolution enhancement within the decoder.

Thus, according to one broad aspect of the present invention there is provided a method for Super-Resolution image reconstruction, the method comprising:

processing data indicative of a video frame sequence compressed by motion compensated compression technique, and obtaining representations of one or more video objects (VOs) appearing in one or more frames of said video frame sequence;

utilizing at least one of said representations as a reference representation and obtaining, from said data indicative of the video frame sequence, motion vectors associating said representations with said at least one reference representation;

processing said representations and said motion vectors and generating pixel displacement maps each associating at least some pixels of one of said representations with locations on said at least one reference representation, at least one of said displacement maps having a sub pixel accuracy;

re-sampling said reference representation according to the sub-pixel accuracy of said displacement maps, and obtaining a re-sampled reference representation, and

registering pixels of said representations against the re-sampled reference representation according to said displacement maps thereby providing super-resolved image of the reference representation of said one or more VOs.

According to the SR method of the present invention, a sequence of successive video frames of a scene are processed together to obtain a high resolution video sequence. A typical video sequence includes several video objects (VO), such as the scene's background or various foreground objects, which features and motions are presented within the frames of the sequence. Each frame may or may not include a representation of a video object (or a part thereof) appearing within the sequence.

Analyzing the motion between the frames enables to separate each of the frames into the VO(s) components. Additionally, the representations of a certain VO appearing within different frames may be such that said representations are associated with one another and they may be further processed as described below to provide an SR enhanced representations of said VO.

It should be understood that in some cases of SR processing of a video sequence it is sufficient to separate a single VO (typically, the background VO appearing in the video sequence) from other components appearing in the video sequence. Accordingly, SR enhancement might be performed on said single VO. It should be also understood that in some embodiments of the present invention a video frame sequence is considered to present a single VO. In this case the frames of the sequence represent the representations of said single VO.

According to some embodiments of the SR method of the present invention, a representation of at least one of the VOs (termed here below reference representation) is processed together with other representation(s) of said at least one VO to produce therefrom an SR enhanced reference representation. The reference representation is in the form of a reference frame when the VO is the background portion of the scene or when the video frame sequence is considered to present a single VO.

Preferably, the motion compensated compression technique includes at least one of MPEG-4 and ITU-H.264 coding standards. The compressed video frame sequence may include at least one GOP.

As indicated above, VO(s) may include a background VO. In this case, the compressed video sequence may comprise GMC data indicative of global motion between the frames. The representations of such background VO is obtained from the video sequence by a background-foreground separation technique based on the GMC data. The reference representation is thus a reference frame obtained from the video frame sequence, e.g. by processing one or more frames of the sequence. The reference frame may be obtained from said video frame sequence by identifying therein a frame suitable for use as a reference frame, e.g. an intra coded frame.

In some embodiments of the invention, the processing of data indicative of a video frame sequence includes obtaining motion vectors, associating pixels of one frame with locations in another frame, and utilizing these motion vectors to analyze the motion between the frames and to facilitate separation of the video sequence data into separate VOs and their corresponding representations.

In some other embodiments, processing of data indicative of the compressed video frame sequence includes obtaining one or more VOs from said data. The video sequence may be compressed by MPEG-4 visual compression standard.

In some embodiments of the invention, the sub-pixel accuracy of the pixel displacement maps is determined by the sub-pixel accuracy of the corresponding motion vectors used for generating said displacement maps. The pixel displacement map may be processed with its corresponding representation of said one or more VOs and the reference representation to provide a respective displacement map having finer sub-pixel resolution.

The re-sampling of the reference representation may be performed in accordance with the sub-pixel accuracy of the displacement maps. Alternatively or additionally, the re-sampling of the reference representation is performed in accordance with the desired resolution enhancement of said super resolution reconstruction process.

The super-resolved image of the reference representation may be further processed by iterative re-interpolation methods.

According to another broad aspect of the invention, there is provided a method for real time Super-Resolution image reconstruction, the method comprising:

processing data indicative of a video frame sequence compressed by MPEG-4 compression standard, and obtaining representations of one or more video objects (VOs) appearing in one or more frames of said video frame sequence;

utilizing at least one of said representations as a reference representation and obtaining, from said data indicative of the video frame sequence, motion vectors associating said representations with said at least one reference representation;

processing said representations and said motion vectors and generating pixel displacement maps each associating at least some pixels of one of said representations with locations on said at least one reference representation, at least one of said displacement maps having a sub pixel accuracy;

re-sampling said reference representation according to the sub-pixel accuracy of said displacement maps, and obtaining a re-sampled reference representation, and

registering pixels of said representations against the re-sampled reference representation according to said displacement maps thereby providing super-resolved image of the reference representation of said one or more VOs.

According to yet another aspect of the invention, there is provided a method for use in obtaining real time Super-Resolution enhanced video, the method comprising:

processing data indicative of a video frame sequence compressed by motion compensated compression technique, and obtaining representations of one or more video objects (VOs) appearing in one or more frames of said video frame sequence;

utilizing at least one of said representations as a reference representation and obtaining, from said data indicative of the video frame sequence, motion vectors associating said representations with said at least one reference representation;

processing said representations and said motion vectors and generating pixel displacement maps each associating at least some pixels of one of said representations with locations on said at least one reference representation, at least one of said displacement maps having a sub pixel accuracy;

re-sampling said reference representation according to the sub-pixel accuracy of said displacement maps, and obtaining a re-sampled reference representation, and

registering pixels of said representations against the re-sampled reference representation according to said displacement maps thereby providing super-resolved image of the reference representation of said one or more VOs;

for each one of said representations, re-sampling the representation according to resolution of the super-resolved referenced representation; utilizing said pixel displacement map to register pixels of said super-resolved reference representation within the respective one of said representations; thereby obtaining a super-resolved video.

The present invention, in its further aspect, provides a system for use in real time Super-Resolution image reconstruction, the system comprising a processing utility configured and operable for processing data indicative of a video frame sequence compressed by motion compensated compression technique, said processing utility comprising:

a video-objects separation module adapted to process said video frame sequence and to obtain therefrom representations of one or more video objects (VOs) appearing in one or more frames of said video frame sequence;

a pixel displacement analysis module adapted to process motion vectors of said compressed video sequence and to generate pixel displacement maps of sub pixel accuracy associating pixels of one or more representations of a VO with locations in another representation of said VO;

a re-sampling module adapted to utilize a representation of a VO having a first pixel resolution and to generate therefrom a re-sampled representation of said VO having a second different pixel resolution and;

a pixel registration module adapted to provide SR enhancement of a re-sampled representation of a VO by utilizing pixel displacement maps, generated by said pixel displacement analysis module, to register pixels of one or more representations of said VO within said re-sampled representation.

In some embodiments, the video-objects separation module operates to process said video frame sequence by utilizing the pixel displacement maps generated by said pixel displacement analysis module. Alternatively or additionally, the compressed video sequence includes GMC data, in which case the video-objects separation module operates to process said video frame sequence by utilizing said GMC data.

In some other embodiments, e.g. where the video sequence is compressed utilizing MPEG-4 visual, the compressed video sequence includes VO data, and the video-objects separation module operates to process said video frame sequence by utilizing said VO data.

More specifically, the present invention is intended for use as a practical super-resolution scheme utilizing MPEG-4 features, and is exemplified below with reference to this specific example. It should however be understood that the invention can be used with any other suitable video compression technique being a motion compensated compression technique. The invention provides for producing, in real-time, good quality higher-resolution videos from low-resolution video streams or from turbulent degraded video streams with discrimination of turbulent from real motion which is caused by moving objects or global camera translations.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is flow diagram of an example of the method of the present invention for SR enhancement of a VO representation;

FIG. 2A is an example of using the invention for reconstructing the SR image of a VO appearing in a video frame sequence;

FIG. 2B exemplifies a sequence of frames following a reference frame in a particular GOP including an I-frame and B- and P-frames;

FIG. 2C exemplifies the main steps of the SR video sequence reconstruction method;

FIG. 3 is a block diagram of an example of a system for super-resolution reconstruction of an image or video frame sequence according to the invention;

FIGS. 4A-4D show the results of an example of the present invention for super resolution processing of video sequences encoded utilizing the MPEG-4 compression standard, where the video sequence includes global camera motion in between the frames; and

FIGS. 5A-5D show the results of an example of the present invention for super resolution processing of video sequences encoded utilizing the MPEG-4 compression standard, where the video sequence includes pixel shifts caused by turbulence effects.

### DETAILED DESCRIPTION OF EXEMPLARY EMBODIMENTS

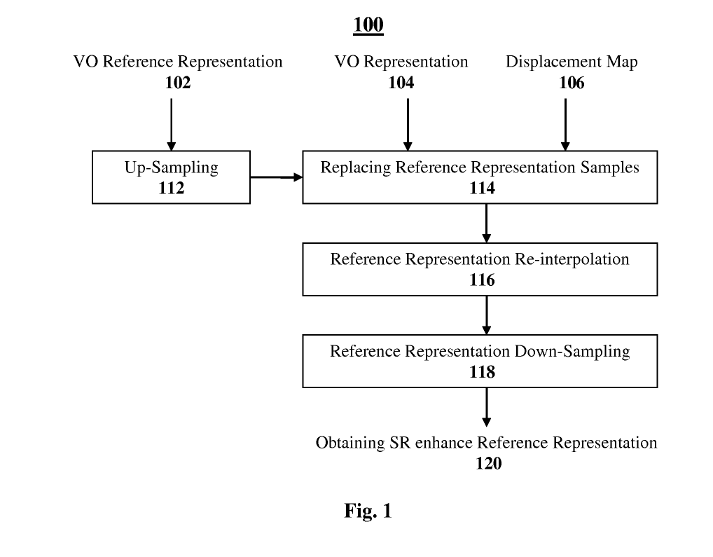

Referring now to FIG. 1, there is illustrated schematically, by way of a flow diagram 100, an example of the method for SR enhancement of a VO representation according to an embodiment of the present invention. Generally, as described above, a video sequence (comprising one or more time windows, sometimes referred to as GOPs) is analyzed and divided into one or more VOs and the representations of said VOs as it/them appear(s) in the video frames of the video sequence. The relations, e.g. in the form of pixel displacement maps, between the representations of the particular VOs (which are to be SR enhanced) are also determined based on the motion vectors of the compressed video sequence, as will be further described below. The technique presented here utilizes the representations of a VO for the SR enhancement of said VO.

First, a reference representation 102 is selected/generated from the representations of said VO. This reference representation is processed and SR enhanced as will be exemplified more specifically below. The processing of the reference representation includes re-sampling (e.g. up-sampling) according to the accuracy of the pixel displacement maps and/or according to the desired output resolution of the SR enhancement process (step 112).

Then, at least some of the representations of the VO (appearing in the reference representation) and the corresponding pixel displacement maps are processed such that each representation (e.g. being a current frame) 104 and its corresponding pixel displacement map 106 are used to adjust the values of pixels within the up-sampled reference representation (step 114). Such adjustment is carried out in accordance with the values of the pixels of the representation 104 and in accordance with the destination locations of these pixels within the up-sampled reference frame. The destination locations can be obtained from the corresponding pixel displacement map 106 associating the reference representation 102 and the representation 104.

It should be noted that step 114 is carried out for each of said at least some representations and corresponding displacement maps. Accordingly, the adjustment (amendment/replacement) of the pixel value of the up-sampled reference representation is made by “averaging” (plain average, median, etc.) the values of multiple pixels of one or more representations associated therewith, e.g. through the corresponding displacement maps, with said pixel being amended.

After step 114 have been repeated for each of said at least some representations of the VO, additional interpolation, such as iterative re-interpolation algorithm, is performed (step 116) on the up-sampled and amended reference representation. This enables to introduce high frequency data into regions (e.g. groups of pixels) of said up-sampled and enhanced reference representation, in which the pixels where not amended. Thereafter, an image down-sampling procedure is applied to the re-interpolated reference representation (step 118), and output data is generated (step 120) corresponding to an image data of a desirably increased SR.

As indicated above, the reference representation may be associated with a VO being a background portion of the scene, and thus is referred to as a reference frame. Also, elastic registration (optical flow), with sub-pixel accuracy, of the values of pixels of several representations of the VO (e.g. as appearing in several frames of the sequence) into an up-sampled reference representation of the VO can be used. This may for example include registering the pixels of the stable portions (e.g. the background portions) of the scene, presented in the sequence of video frames, with a reference frame of the scenery. Re-sampling (typically up sampling) of the VO representations (e.g. the frames) according to the registration results is preformed either after or prior to the elastic registration.

In the description below, the term elastic registration generally refers to analyzing motion fields between two or more frames of the video sequence (e.g. generation of pixel displacement maps) from which the translations of pixels from one frame to the other and the position of a pixel within different frames may be obtained.

The reference frame is an estimate of the stable (non-moving) scene obtained from the input video sequence. In order to achieve optimal results, the reference image should preferably have the following properties:
The reference image contains only the static background with no moving objects in it;
The reference image contains no distortions and global camera movement.

In some embodiments of the invention, an SR reference frame of the background portion of a scene is produced for each scene of the video sequence in which a different background appears and from which SR video sequence is to be produced. Hence, an arbitrary video sequence, which may contain several scenes possibly occurring on different backgrounds, is divided into sub sequences. The video sequence may be analyzed and divided into several time windows (sub-sequences) presenting different scenes. Alternatively, the compressed sequence is divided into several sub-sequences each being associated with one or more GOPs of the compressed video.

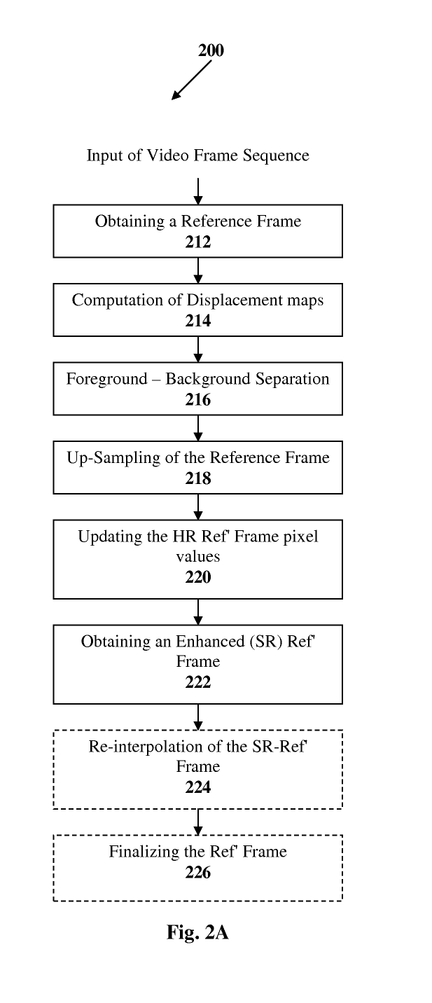

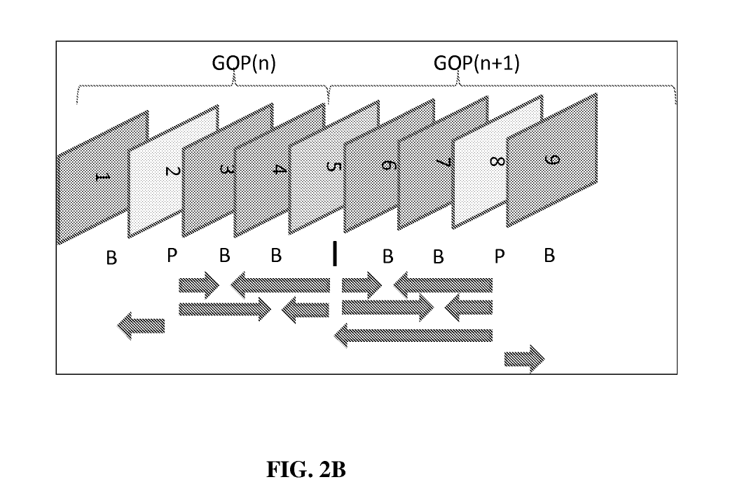

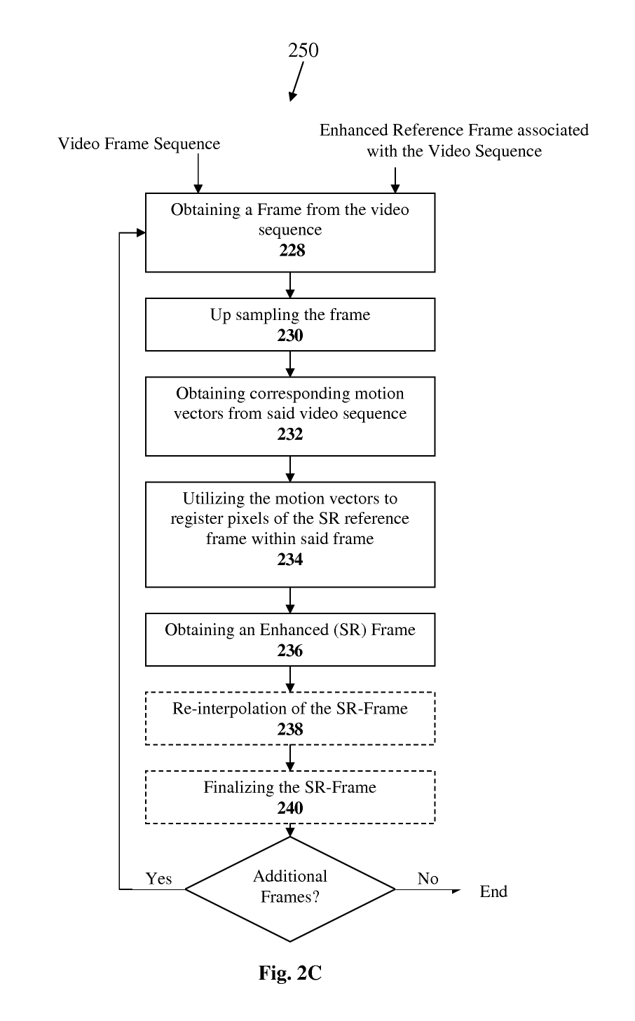

At least some of said video sequences (e.g. sub-sequences) are processed to obtain therefrom, in real-time, an SR image of the stable portion (background) of the scene present therein. Reference is made to FIG. 2A, illustrating, by way of a flow diagram 200, an example of the technique for reconstructing the SR image of a VO appearing in a video frame sequence, using the technique of the present invention.

Initially, a compressed video sequence of several frames is received and stored. In the following description, the term video sequence refers to one or more GOPs from which a super resolution reference frame is obtained (i.e. sub sequence).

In step 212, a reference frame is obtained for use in the procedure of pixel-elastic registration described below. The reference frame might be any suitable frame in the sequence or alternatively may be one computed from several frames of the sequence by using for example averaging of the preceding frames (e.g. temporal pixel-wise median taken with respect to the relative displacement of pixels between the frames).

When utilizing a video compressed using the MPEG standard, data indicative of each of the processed frame sequences is included within one or more GOPs. Then, it might be preferable to use the I-frame related data of the preceding GOP (which is computed by the MPEG-4 decoder) as a reference frame for the SR processing of the proceeding GOP(s) of the MPEG encoded sequence.

Using the MPEG standard based model, an I-frame beginning a particular GOP is the reference frame. The SR algorithm of the present invention requires data indicative of motion vectors connecting the reference frame/representation with all other frames. Therefore, only the neighboring frames up to and including the first P-frame in the current GOP and the frames down to and excluding the last P-frame in the previous GOP are integrable with the I-frame. The frames following the reference frame in a particular GOP have predictions which are directly connected to macro-blocks within said reference I-frame. This is illustrated in FIG. 2B. Frames 1-4 in the figure relate to a group GOP₍ₙ₎, while frames 5-9 are associated with groups GOP₍ₙ₊₁₎. Frame 5 is the I-frame starting the group GOP₍ₙ₊₁₎, frames 1,3,4,6,7 and 9 are B-frames and frames 2 and 8 are P-frames. The arrows going into each frame represent the frames from which motion field is computed for each P- and B-frame, e.g. frame 6 integrates data from frames 5 and 8. The figure exemplifies that mutual motion information between frame 5 and the other frames exists only for frames 2-8, thus those are the frames that can be used for SR without applying any additional processing.

When integration of more than one GOP into the SR process is desired (e.g. when the sub-sequence of video frames includes more than one GOP), for every new I-frame, the translations (e.g. motion vectors) with regards to the reference I-frame, which are not included in the compressed video sequence, are computed. These motion vectors may be computed by using one of the known search algorithms.

Turning back to FIG. 2A, in step 214, each frame of the sequence, and the motion vectors associated therewith, are processed against the reference frame and a map of the displacement of the frame's pixels with respect to the reference frame is computed with sub pixel accuracy. This processing is performed for one or more frames of the sequence and a collection of displacement maps each associated with different frame are used in the SR enhancement of the reference frame as described below. It should be understood that the reference frame SR enhancement procedure might be carried out incrementally, such that each frame (i.e. each representation of the VO(s) presented in the reference frame) is used to improve, incrementally, the SR enhancement of the reference frame.

Generally, it is known in the art to map regions/pixels of a first frame to corresponding locations on a second frame by using search algorithms such as Logarithmic Search, Hierarchical Search, Cross Search, Asymmetrical Cross Multi Hexagon-grid (AMHexagonS) and Enhanced Predictive Zonal Search (EPZS) [3, 10, 11]. These search algorithms, typically, produce heavy computational load and are not adequately suited for use during real-time decoding and SR processing of a video sequence. However, using a video sequence encoded utilizing motion compensated compression technique, such as MPEG, similar mappings (searching) processes have already being made during the encoding stage of the video sequence and its results are stored in the encoded data in the form of motion-vectors associating macro-blocks of one frame with locations in another frame. Thus, according to the present invention, these motion vectors are used in order to produce displacement maps representing the displacement of pixels between two frames of the sequence. This minimizes the amount of processing that is required and facilitates real-time performance of the SR image reconstruction. The pixel displacement map is then analyzed, in step 216, and segmented to separate and distinguish between the pixels of distinct VOs of the scene. Typically, separating the pixels of real moving objects (foreground) from those which belong to the background of the scene (e.g. background-foreground separation) and which are displaced solely due to the atmosphere turbulence or global camera movements is sufficient for reconstructing SR images of the scene.

According to some embodiments of the present invention, the features of the MPEG-4 Visual coding standard are used for an efficient segmentation of the video frames into distinct VOs. Generally, MPEG-4 Visual represents a video sequence as a collection of one or more VOs encoded as flexible entities that may be separately manipulated. For example, a video scene may include a background related VO and a number of separate foreground related VOs. This approach is much more flexible than the fixed, rectangular frame structure of earlier standards. The separate objects may be exploited for both efficient background separation and for separate SR processing of each VO.

Alternatively or additionally, an efficient extraction of global motion between frames of the video sequence might be achieved, when the compressed video sequence is encoded with Global Motion Compensation (GMC). GMC is generally known and need not to be described in details, expect to note the following: GMC enables to encode a small number of motion (warping) parameters that describe a default ‘global’ motion (e.g. macro-blocks within the same VO which experience similar motion). Thus, GMC may provide for improved motion analysis and real motion extraction thereby enabling an efficient background-foreground separation.

The displacement maps thus obtained and the object discrimination (e.g. background-foreground separation) process enable to utilize the reference frame and to reconstruct therefrom an SR image. In step 218, the reference frame is up-sampled (e.g. via known interpolation methods) to match the sub-pixel accuracy of the displacement maps. Then, in step 220, the pixels of the up-sampled reference frame are updated/computed based on the displacement maps and the values of pixels in the video frames corresponding therewith. For example, pixels of each frame are placed in the reference frame, according to their locations determined by the corresponding displacement map. Therefore, each pixel in the up-sampled reference frame may be associated with multiple pixels of one or more frames of the sequence.

The values of such multiple pixels are then averaged for example by computing median of those pixels in order to avoid influence of outliers that may appear due to possible anomalous errors in the displacement maps.

As a result of the pixel elastic registration procedure described above, the reference frame, stabilized and enhanced in its resolution, is obtained in step 222. The enhanced reference frame, in positions where substitutions from other frames of the sequence occur, contains accumulated pixels of these frames and, in positions where no substitutions occur, contains interpolated pixels of the reference frame.

Substituted pixels introduce to the output frame high frequencies outside the base-band defined by the original sampling rate of the input frames. Those frequencies were lost in the input frames due to the sampling aliasing effects. Interpolated pixels that were not substituted do not contain frequencies outside the base-band. Optionally, in order to finalize the process and take full advantage of the super-resolution provided by the substituted pixels additional processing, such as iterative re-interpolation algorithm [6, 7], may be used in step 224.

The output-frame, stabilized and resolution-enhanced image obtained according to the SR process described above may be subjected to additional processing (step 226) such as sub-sampling to the sampling rate determined by selected enhanced bandwidth and additional corrective processing aimed at camera aperture correction, denoising and reducing blocking (de-blocking) and ringing effects (de-ringing).

Reference is made to FIG. 2C showing schematically, in the form of a flow diagram 250, the main steps of SR video sequence reconstruction method.

In this example, an input sequence of video frames and an enhanced SR reference frame associated therewith are provided and a corresponding SR sequence of video frames is produced therefrom. The enhanced reference frame, the corresponding displacement map and the foreground-background separation data might be obtained similarly as disclosed in connection to FIG. 2A above.

It should be noted that steps 228 to 240 detailed below occur for each frame of the sequence that should be SR enhanced. In the first step 228, a frame, to be enhanced is obtained from the video sequence. For clarity the frame is treated, in the description below, as if it is in its “uncompressed” form, e.g. a bitmap. However, it should be understood that in the general case the frame might be similarly processed, while represented in its compressed (intra-coded or inter-coded) form.

In the next step 230, the processed frame is up-sampled according to the sampling resolution of the enhanced reference frame. Alternatively, the frame and the enhanced reference frame might both be re-sampled to the required output resolution. Then, in step 232, the motion vectors of the compressed video sequence which associate pixels of the reference frame with the location on the processed frame are obtained, or alternatively the corresponding pixel displacement maps such as those obtained in step 214 above are used to register (in step 234) pixels of the SR enhanced reference frame into the processed frame which was correspondingly up-sampled in step 230.

Similarly to the reference frame obtained in step 222 of FIG. 2A above, the processed frame obtained at this stage (step 236) contains some pixels which where interpolated during the up-sampling stage and contains other pixels registered by the reference frame which include higher frequency data. The optional finalizing processing steps 238 and 240 are similar to steps 224 and 226 described above with reference to FIG. 2A.

The processing of additional frames of the sequence may continue from step 228 until no additional frames associated with the particular input SR reference frame are found.

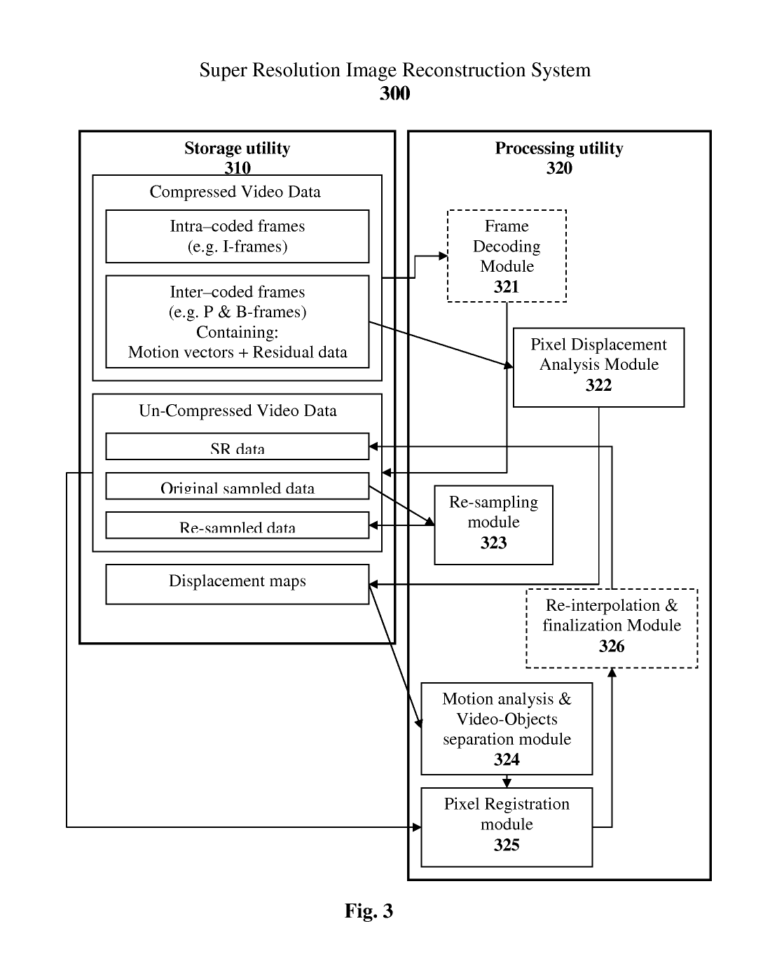

Turning now to FIG. 3, there is illustrated in the form of a block diagram a system for super-resolution reconstruction of an image or video frame sequence. The system comprises a processing utility 320 and a storage utility 310 adapted for storing therein compressed and uncompressed video sequences, and for storing additional (transient) data that may be required/produced in the SR image/video reconstruction process. The processing utility 320 includes several modules 321-325 which are configured and operable for carrying out the SR video frame(s) reconstruction process according to the methods of the present invention.

The Frame Decoder Module 321 is adapted for decoding video frames from the compressed video sequence. As was mentioned above, compressed frames might be inter- or intra-coded frames and thus the Frame Decoder Module 321 is capable of decoding both types of coded frames. According to some embodiments of the process, a compressed sequence of video frames, that is to be reconstructed with super-resolution enhancement, is first decoded (e.g. uncompressed) and then an SR process, according to the present invention, operates one both compressed and uncompressed video data by utilizing the compressed video data to provides the motion vectors correlating the locations of different regions (e.g. Macro-Blocks) in between different frames (e.g. in their uncompressed representation) thereby facilitating the rest of the SR process to operate on the uncompressed data. Alternatively, according to other embodiments, an initial decoding of the some frames of the video sequence is not required. For example, at first only the frame used as a reference frame for a particular sub-sequence is decoded. Then SR processing of this reference frame might utilize the compressed data (e.g. motion vectors and residual data) for SR enhancing the reference frame with similar methods as described above with reference to FIG. 2A.

The techniques described in FIG. 2C for utilizing the SR enhanced reference frames for SR enhancement of other frames of the video sequence may operate directly on the compressed frames of the sequence (e.g. by re-sampling residual data appearing in these compressed frame and recalculating/rescaling the motion vectors/pixels displacement maps to refer to the enhanced reference frame instead of the original frame). Such a process will actually utilize the encoded frame of the video sequence to generate there from encoded SR-enhanced frames directly without an initial decoding of the frames. Accordingly the Frame Decoder Module 321 might operate to decode such frames directly to their SR enhanced version.

The Pixel Displacement Analysis Module 322 is adapted to utilize and process motion vectors of the compressed video sequence and the video sequence itself (in either compressed or uncompressed from) and to generate therefrom Pixel Displacement Maps, each associating, e.g. with sub-pixel accuracy, pixels of one or more frames of the sequence with locations in another frame (e.g. in a reference frame). The Pixel Displacement Maps thereby produced facilitate for the motion analysis and video object separation carried out by the Module 324 and for the pixel registration carried out by the Module 325. According to the present invention, the pixel displacement maps are created based on the motion of macro-blocks in between frames which is encoded within the compressed video via motion vectors.

In known motion compensated compression standards, motion vectors have sub-pixel accuracy down to ¼^{th} of a pixel. However, these motion vectors may be further processed together with their respective frames to provide for pixel displacement maps having finer pixel motion accuracy (e.g. ⅛^{th} of a pixel) higher than that provided by the motion vectors of the compressed video sequence. Additionally, it should be noted that some of the pixels of an inter-coded frame (e.g. coded with motion vectors being references to macro-blocks of another frame) may not be associated, via motion vectors, with the pixels in another frame. This is mainly due to the differences between the frames and also due to size of the macro-blocks which contains substantial number of pixels (e.g. 16×16). Thus, some of these pixels might be mapped, e.g. using the various searching algorithms described above, to thereby obtain a complete pixel displacement map.

The re-sampling module 323 of the processing unit is adapted for re-sampling an image of a given resolution to a higher (up-sampling) or lower (down-sampling) resolutions as required. This module utilizes know techniques, typically interpolation techniques such as discrete sinc-interpolation to resample an image. According to the SR process of the present invention pixel displacement maps of sub pixels accuracy are computed to correlate the pixels of one frame with sub pixel resolution location within another frame. This is aimed at registering these pixels within sub-pixels locations at said another frame to thereby introduce, into said another frame, data of special frequency higher that the special frequency at which it was rendered (encoded) in the first place. Thus, registering into said other frames data of finer (e.g. sub-pixel) resolution is achieve by the re-sampling (up-sampling) of the frame to match the accuracy of the pixel displacement maps used. For example, if the sub-pixel accuracy of the displacement maps is a ¼ of pixels along each direction then the target frame of the pixel registration should be up sampled to include 4 times the number of pixels in each direction.

The re-sampling module 323 is also used, according to some embodiments of the invention, for up/down sampling of an enhanced image into the output resolution required.

The pixels displacement maps obtained above enable to utilize the video sequence and to render video frames or portions thereof (e.g. specific video objects such as the background of the scene or other objects moving within the scene) with super resolution properties (including higher frequency data of the rendered object). This may be achieved by the separation and association of the video sequence data with the different objects appearing therein.

The Motion analysis & Video-Objects separation module 324 provides such separation and association of the video data with different moving object by utilizing the pixels displacement maps to analyze the motions of different objects within the scene. This enables to separate the pixels appearing in each frame of the video sequence to several groups of pixels each associated with a corresponding video object. Accordingly, after such separation is made, each video object recognized is associated with typically more then one such groups of pixels (each from a different frame) and with the corresponding portions of the sub-pixel accuracy pixel displacement maps which can be utilize for registration of the video objects pixels (as described above) by the Pixel Registration module 325. Thereby an SR reconstruction of the video object may be achieved.

The Motion analysis & Video-Objects separation module 324 might utilize any of the techniques suitable for motion analysis, for example optical-flow. The motion induced differences between successive video frames may be divided into two different types of motions. The first is the Global (e.g. camera movement) between the frames of the scene including for example zoom, pan, tilt etc and the second is the “real” motion of different objects within the scene.

According to some embodiment these motions are analyzed by the Module 324 from the pixel displacement maps which are segmented to separate pixels of the “real” moving objects from those that belong to the background. Alternatively, as described above, according to some video coding standards, such as the MPEG-4 visual, the encoded (compressed) sequence include data indicative of different VOs present in the video stream. In this case, the separation and division of the video data into separate objects have already taken place during, or prior to, the encoding of the video sequence. Having such feature existing in the encoded video sequence might facilitate efficient separation and association of the video data and the pixel displacement maps into different VOs.

In cases when the main VO that is processed and SR reconstructed is the background portion of the scene, only Foreground-Background analysis/separation is required. In this case, Global Motion Extraction techniques may be used or alternatively if the compressed video sequence already includes Global Motion Compensation (GMC) data, this data may provide for the efficient separation of foreground/background.

Pixel Registration module 325 is configured and operable for producing an SR enhanced representation of one or more video objects appearing in the video sequence. A VO, in this case, may include an up-sampled reference frame presenting the background of the scene or alternatively or additionally the up-sampled representations of the foreground objects of the scene separated from the video sequence as described above. In the pixel registration procedure of a video object, carried out by thus module 325, one of the up-sampled representation of the video objects (e.g. as represented in one of the frames of the video sequence) is taken as a reference representation (for example an up-sampled I-frame might be taken as a reference representation for the background VO). The pixels appearing in the remaining representation of the video object are registered, in accordance with the corresponding portion of the pixels displacement maps, and accumulate in their respective location within the reference representation of the VO. In order to obtain enhanced SR representation of the VO, the pixel value of each location within the reference representation, is calculated by taking an “average” (e.g. median, average and so forth) of the pixels (of the different representations of VO) that were accumulated there.

Additional modules, which may be used to finalize the processing of the SR enhanced frames, may include re-interpolation module 326 which is operated to process the enhance SR representations of the VO to introduce high frequency modes appearing in regions in which pixels from several representations of the VO where introduced into the regions of the enhanced SR representation.

Other modules, also not shown, may include camera aperture correction module, de-noising, de-ringing, de-blocking and other common modules used in the decoding of a motion compensated encoded videos. The MPEG-4 Visual describes a deblocking filter and a deringing filter as optional and thus both filters are designed to be placed at the output of the decoder. Thus, in the decoding stage the unfiltered decoded frames are used as the reference for motion-compensated reconstruction of further frames. This may enable an integration of the SR techniques of the present invention with the decoding process of video sequences compressed according to this standard.

It should be understood the system shown in FIG. 3 may also be used for carrying out the method shown in FIG. 2C, namely utilizing the enhanced SR reference representation in order to SR enhance the remaining representations of the VO.

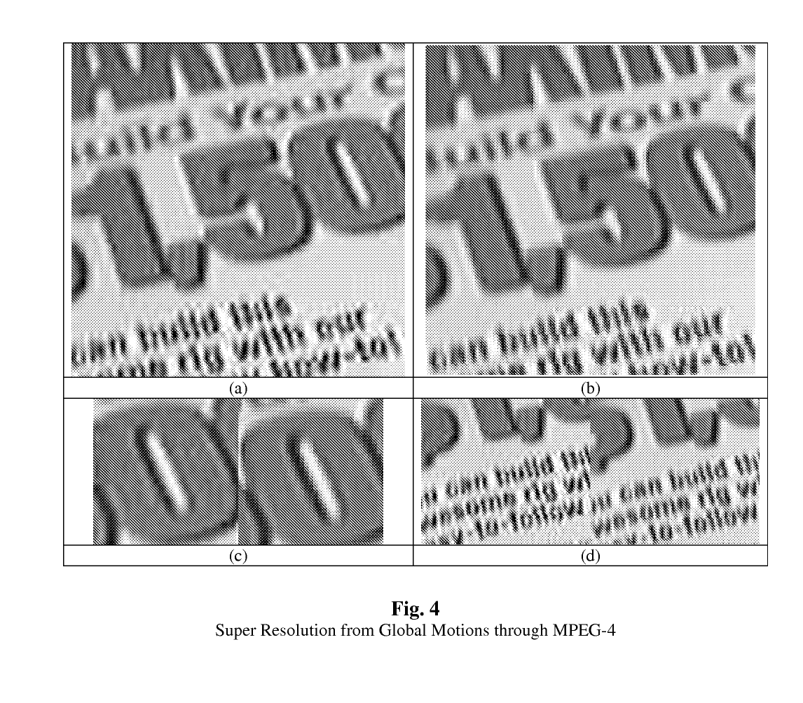

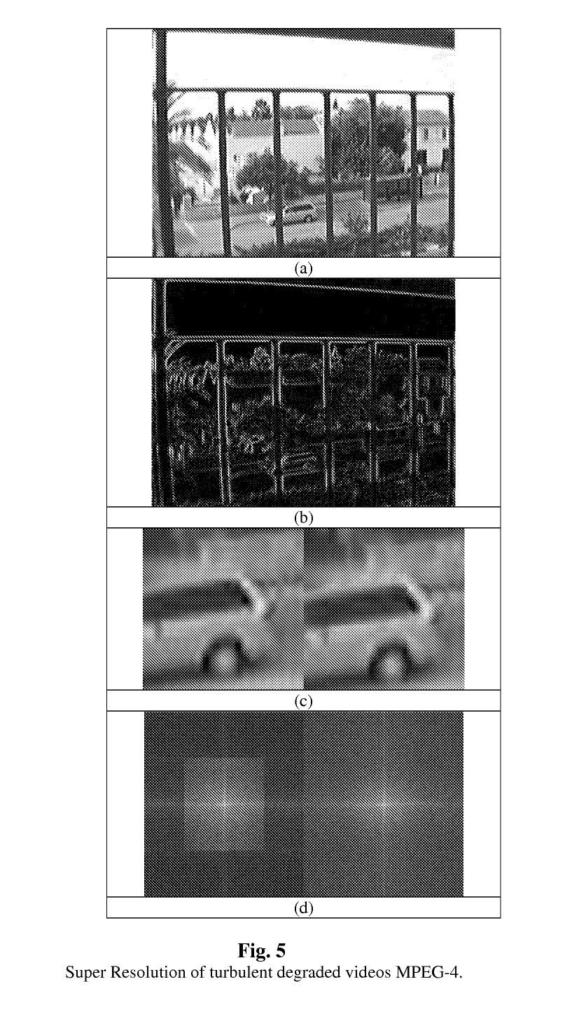

FIGS. 4A-4D and 5A-5D show the results of using the present invention in super resolution processing of video sequences encoded utilizing the MPEG-4 compression standard.

FIGS. 4A-4D depicts the super-resolution process, through MPEG-4, applied on a real-life video sequence containing translations due to global motion between the frames. The sequence was acquired with 320×240 pixels webcam. FIG. 4a presents the first frame extracted from the sequence interpolated (re-sampled) to twice, on each axis, of its original size. FIG. 4b is an SR enhanced image obtained by processing, according to the techniques of present invention, 50 frames of the video sequence. The translation of each frame with regards to the first frame, which is the first I-frame of the video sequence, was computed using the MPEG-4 diamond search with quarter pixel accuracy. FIGS. 4c and 4d present fragments extracted from FIGS. 4a and 4b respectively. The left-hand side parts of FIGS. 5c and 5d are interpolated and the right-hand parts are the corresponding SR fragments.

FIGS. 5a-5d presents the results of an SR enhancement process of a video frame sequence containing translations between the frames caused by turbulent pixel motion. A super-resolved frame computed using 150 frames of a turbulent degraded sequence is presented in FIG. 5a. FIG. 5b depicts the absolute difference of the super-resolved image and the reference frame interpolated to four times of its original size. As shown in this figure, most of the difference's energy is located in the vicinity of edges.

FIG. 5c shows, on its right-hand side, a fragment extracted from the interpolated reference frame. On the left-hand side of this figure, a corresponding fragment extracted from a super-resolved reference frame is shown. It can be seen from the figure that the SR fragment contains finer details of the scene then the interpolated one. The spatial frequency distributions, (spectra) corresponding to the interpolated and the super-resolved fragments shown in FIG. 5c, are shown respectively on the right and left hand sides of FIG. 5d. It can be seen from the spectra distributions that the super-resolution fragment includes high frequency data which is not included in the interpolated fragment.

Thus, the present invention provides a simple solution for SR enhancement of images obtained from a video sequence. This solution is also time- and power-effective as compared to known techniques of the kind specified. Those skilled in the art will readily appreciate that various modifications and changes can be applied to the embodiments as hereinbefore described without departing from its scope defined in and by the appended claims.

1. A method for real time Super-Resolution image reconstruction, the method comprising:
processing data indicative of a video frame sequence compressed by motion compensated compression technique, and obtaining representations of one or more video objects (VOs) appearing in one or more frames of said video frame sequence;
utilizing at least one of said representations as a reference representation and obtaining, from said data indicative of the video frame sequence, motion vectors associating said representations with said at least one reference representation;
processing said representations and said motion vectors and generating pixel displacement maps each associating at least some pixels of one of said representations with locations on said at least one reference representation, at least one of said displacement maps having a sub pixel accuracy;
re-sampling said reference representation according to the sub-pixel accuracy of said displacement maps, and obtaining a re-sampled reference representation, and
registering pixels of said representations against the re-sampled reference representation according to said displacement maps thereby providing super-resolved image of the reference representation of said one or more VOs.

2. The method of claim 1 wherein said motion compensated compression technique includes at least one of MPEG-4 and ITU-H.264 coding standards.

3. The method of claim 2 wherein said compressed video frame sequence includes at least one GOP.

4. The method of claim 1 wherein said one or more VOs include a background VO.

5. The method of claim 4 wherein said compressed video sequence comprises Global Motion Compensation (GMC) data indicative of global motion between the frames, and wherein the representations of said background VO is obtained from the video sequence by a background-foreground separation technique based on said GMC data.

6. The method of claim 4 wherein said reference representation is a reference frame obtained from said video frame sequence.

7. The method of claim 6 wherein said reference frame is obtained from said video frame sequence by processing one or more frames of the sequence.

8. The method of claim 1 wherein said processing of said data indicative of a video frame sequence includes obtaining therefrom motion vectors associating pixels of one frame with locations in another frame and utilizing said motion vectors to analyze the motion between the frames and to facilitate separation of the video sequence data into separate VOs and their corresponding representations.

9. The method of claim 1, wherein said processing of said data indicative of the compressed video frame sequence includes obtaining one or more VOs from said data.

10. The method of claim 9, wherein the video sequence is compressed by MPEG-4 visual compression standard.

11. The method of claim 6 wherein said reference frame is obtained from said video frame sequence by identifying therein a frame suitable for use as a reference frame.

12. The method of claim 11 wherein said reference frame is an intra coded frame.

13. The method of claim 1 wherein the sub-pixel accuracy of said pixel displacement maps is determined by the sub-pixel accuracy of the corresponding motion vectors used for generating said displacement maps.

14. The method of claim 13 wherein at least one of said pixel displacement maps is processed with its corresponding representation of said one or more VOs and the reference representation to provide a respective displacement map having finer sub-pixel resolution.

15. The method of claim 1 wherein said re-sampling of said reference representation is performed in accordance with the sub-pixel accuracy of said displacement maps.

16. The method of claim 1 wherein said re-sampling of said reference representation is performed in accordance with the desired resolution enhancement of said super resolution reconstruction process.

17. The method of claim 1 wherein said super-resolved image of the reference representation is further processed by iterative re-interpolation methods.

18. A method for real time Super-Resolution image reconstruction, the method comprising:
processing data indicative of a video frame sequence compressed by MPEG-4 compression standard, and obtaining representations of one or more video objects (VOs) appearing in one or more frames of said video frame sequence;
utilizing at least one of said representations as a reference representation and obtaining, from said data indicative of the video frame sequence, motion vectors associating said representations with said at least one reference representation;
processing said representations and said motion vectors and generating pixel displacement maps each associating at least some pixels of one of said representations with locations on said at least one reference representation, at least one of said displacement maps having a sub pixel accuracy;
re-sampling said reference representation according to the sub-pixel accuracy of said displacement maps, and obtaining a re-sampled reference representation, and
registering pixels of said representations against the re-sampled reference representation according to said displacement maps thereby providing super-resolved image of the reference representation of said one or more VOs.

19. A method for use in obtaining real time Super-Resolution enhanced video, the method comprising:
processing data indicative of a video frame sequence compressed by motion compensated compression technique, and obtaining representations of one or more video objects (VOs) appearing in one or more frames of said video frame sequence;
utilizing at least one of said representations as a reference representation and obtaining, from said data indicative of the video frame sequence, motion vectors associating said representations with said at least one reference representation;
processing said representations and said motion vectors and generating pixel displacement maps each associating at least some pixels of one of said representations with locations on said at least one reference representation, at least one of said displacement maps having a sub pixel accuracy;
re-sampling said reference representation according to the sub-pixel accuracy of said displacement maps, and obtaining a re-sampled reference representation, and
registering pixels of said representations against the re-sampled reference representation according to said displacement maps thereby providing super-resolved image of the reference representation of said one or more VOs;
for each one of said representations, re-sampling the representation according to resolution of the super-resolved referenced representation; utilizing said pixel displacement map to register pixels of said super-resolved reference representation within the respective one of said representations; thereby obtaining a super-resolved video.

20. A system for use in real time Super-Resolution image reconstruction, the system comprising a processing utility configured and operable for processing data indicative of a video frame sequence compressed by motion compensated compression technique, said processing utility comprising:
a video-objects separation module adapted to process said video frame sequence and to obtain therefrom representations of one or more video objects (VOs) appearing in one or more frames of said video frame sequence;
a pixel displacement analysis module adapted to process motion vectors of said compressed video sequence and to generate pixel displacement maps of sub pixel accuracy associating pixels of one or more representations of a VO with locations in another representation of said VO;
a re-sampling module adapted to utilize a representation of a VO having a first pixel resolution and to generate therefrom a re-sampled representation of said VO having a second different pixel resolution and;
a pixel registration module adapted to provide SR enhancement of a re-sampled representation of a VO by utilizing pixel displacement maps, generated by said pixel displacement analysis module, to register pixels of one or more representations of said VO within said re-sampled representation.

21. The system of claim 20, wherein the video-objects separation module operates to process said video frame sequence by utilizing the pixel displacement maps generated by said pixel displacement analysis module.

22. The system of claim 20, wherein said compressed video sequence includes GMC data, the video-objects separation module operating to process said video frame sequence by utilizing said GMC data.

23. The system of claim 20, wherein said compressed video sequence includes VO data, the video-objects separation module operating to process said video frame sequence by utilizing said VO data.

24. The system of claim 23, wherein said video sequence is compressed utilizing MPEG-4 visual.

25. The system of claim 20, further comprising re-interpolation processing module adapted for processing SR representations of a VO to introduce high frequency modes.
